(19) United States
(12) Patent Application Publication
(10) Pub. No.: US 2025/0139350 A1
(43) Pub. Date: May 1, 2025

(54) GENERATIVE PAGE BASED ON SCREENSHOTS

(71) Applicant: Pager Technologies, Inc., Brooklyn, NY (US)

(72) Inventors: Alexander Mahedy, New York, NY (US); Duncan Buck, Berlin (DE); Austin Christian-Durup Armstrong, Brooklyn, NY (US)

(21) Appl. No.: 18/497,344

(22) Filed: Oct. 30, 2023

(51) Int. Cl. G06F 40/106; G06F 40/166

(52) U.S. Cl. CPC G06F 40/106; G06F 40/166

(57) ABSTRACT

Aspects of the disclosure provide for mechanisms for dynamically generating at least one page using one or more screenshots. A method of the disclosure includes receiving a screenshot, identifying a plurality of fragments of the screenshot, wherein each fragment corresponds to one of: structural user interface (UI) elements or content of the screenshot, generating, for each fragment of the plurality of fragments, an entity, wherein the entity is a pre-defined structure representation of the fragment, and generating, based on the entities associated with the plurality of fragments, at least one page associated with the screenshot.

### TECHNICAL FIELD

Embodiments of the disclosure relate generally to memory sub-systems, and, more specifically, relate to dynamically generating a page using one or more screenshots.

### BACKGROUND

Screenshots can be static digital images that capture the display's content (e.g., a computer device, mobile device, etc.) and may be utilized for documentation, communications (e.g., content sharing), illustration, comparison, a memory (screenshot of a moment).

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a block diagram of an example system used to dynamically generate applets (or pages) based on screenshots, in accordance with some embodiments of the present disclosure.

FIG. 2 illustrates a block diagram of an example page generation engine of the system which includes a screenshot observation service, a fragment service, an entity service, and a page service used to dynamically generate pages based on screenshots, in accordance with some embodiments of the present disclosure.

FIG. 3 illustrates a block diagram of the fragment service of the page generation engine, in accordance with some embodiments of the present disclosure.

FIG. 4 illustrates a block diagram of the entity service of the page generation engine, in accordance with some embodiments of the present disclosure.

FIG. 5 illustrates a block diagram of the page service of the page generation engine, in accordance with some embodiments of the present disclosure.

FIG. 6 illustrates a page generated from a screenshot, in accordance with some embodiments of the present disclosure.

FIG. 7 is a flow diagram of an example method for dynamically generating a page based on screenshots, in accordance with some embodiments of the present disclosure.

FIG. 8 is a block diagram of an example computer system in which embodiments of the present disclosure may operate.

### DETAILED DESCRIPTION

Aspects of the present disclosure are directed to dynamically generating a page based on one or more screenshots. The operating system or software on the computer or mobile device creates screenshots. Screenshots utilized for documentation provide users with a method of documenting and recording information. Screenshots utilized for communication provide users a method of communicating information visually to others (e.g., sharing articles, restaurants, shows, songs, videos, and social media posts). Screenshots utilized for memory provide users with a visual memory aid to help capture and remember important information or moments. While a viewer of the screenshot may utilize the screenshot for its intended purpose, viewers of the screenshot must manually search the Internet and/or applications to engage with the content of the screenshot. In some instances, the viewer may not have access to the application captured in the screenshot.

Aspects of the present disclosure address the above and other deficiencies by dynamically generating pages based on one or more screenshots. In particular, optical character recognition (OCR), computer vision, or any other artificial intelligence aimed at interpreting visual data (e.g., screenshots) may be used to obtain observations of the one or more screenshots (e.g., screenshot). Explicit and/or implicit contextual information may be derived from the observation of the screenshot represented as fragments. Each fragment may be schematically structured according to a universal schema represented as entities. Each entity represents factual data relating to online and/or offline data associated with a fragment. Some entities may correspond to content from the screenshot, while others correspond to functionality of the screenshot. Pre-developed and/or on-demand developed functional components may be obtained for entities that correspond to functionality of the screenshot. These entities may be enriched or modified to include the functional components. Based on all entities derived from the screenshot, a page layout may be obtained and used to generate a page. Once the page layout is identified, the entities are used to replace one or more UI elements within the page layout. The page layout with the replaced one or more UI elements generates a page to be deployed to a user.

Advantages of the present disclosure include, but are not limited to, providing users the ability to interact with the content of their screenshots without accessing the original application within the screenshot. In addition, it provides users with a personalized application experience based on their screenshot of screenshots that matches and/or exceeds the functionality of the original application within the screenshot. Various aspects of the above-referenced methods and systems are described in detail below by examples, rather than by limitations.

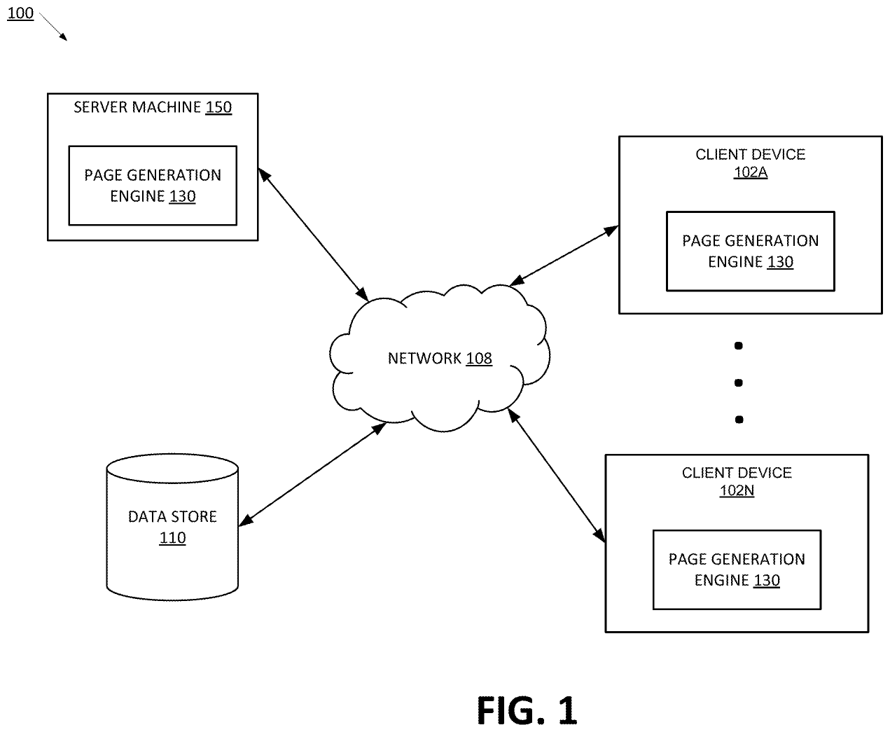

FIG. 1 illustrates an example system architecture 100, in accordance with implementations of the present disclosure. The system architecture 100 (also referred to as “system” herein) includes client devices 102A-N, a data store 110, and/or a server machine 150, each connected to a network 108. In implementations, network 108 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. Data store 110 can be hosted by one or more storage devices, such as main memory, magnetic or optical storage based disks, tapes or hard drives, NAS, SAN, and so forth. In some implementations, data store 110 can be a network-attached file server. In contrast, in other embodiments, data store 110 can be some other type of persistent storage such as an object-oriented database, a relational database, and so forth. Data store 110 can include a media cache that stores copies of screenshots that are received from client devices 102A-N. In one example, screenshots can be a file that is downloaded from client devices 102A-N and can be stored locally in media cache. In another example, screenshots can be stored as an ephemeral copy in memory of server machine 150.

The client devices 102A-N can each include computing devices such as personal computers (PCs), laptops, mobile phones, smartphones, tablet computers, netbook computers, network-connected televisions, etc. In some implementations, client devices 102A-N may also be referred to as “user devices.” Client devices 102A-N can, according to aspects of the disclosure, include a content viewer, such as a web browser or standalone application, for users to save and group screenshots used to display pages in the content viewer.

As illustrated in FIG. 1, client devices 102A-N can include a page generation engine 130. The page generation engine 130 of a client device (e.g., client devices 102A) may obtain one or more static screenshots (herein referred to as screenshot) and generate an applet referred to as a page to be presented in the content viewer. Each of the one or more static screenshots may be stored in a storage of the client devices 102A-N. Accordingly, the page generation engine 130 may retrieve the screenshot from storage of the client devices 102A. Alternatively, the page generation engine 130 may receive the screenshot from an external source (e.g., data store 110).

The page generation engine 130 may obtain observation data from the screenshot. For example, the page generation engine 130, using various techniques, may obtain information directed to attributes of the screenshot, segmentation of the screenshot, and application classifications of the screenshot. Some examples of the various techniques can include, optical character recognition (OCR), computer vision, or any other artificial intelligence aimed at interpreting visual data (e.g., screenshots). As a result, observation data, among other things, includes information used to assist in an identification of the application.

The page generation engine 130 may, based on the observation data, identify an application within the screenshot. The application may be, for example, a social media application, a music application, a web page, a web browser, a messaging application, or any other third-party application. The page generation engine 130 identifies, within the application of the screenshot, structural user interface (UI) elements, content (e.g., non-structural UI elements), and a current state of the application (or application state). The page generation engine 130 may extract, from the screenshot, the identified structural element, content, and application state to generate fragments. Depending on the embodiment, based on the observation data and the identified application, additional fragments associated with the structural UI, content, and/or application state derived from the screen may be extracted from external sources (e.g., a website).

Fragments provide explicit and/or implicit contextual information about the screenshot based on the observation data. Structural UI elements may include, for example, may include icons, buttons, titles, logos, or other suitable UI elements of the application. Content may include text, images, URLs, or any other suitable information associated with the application's contents. For example, for a social media application, the extracted content elements can include images, user name, comments, number of comments, duration of a video post, text, date, and time of the post.

The page generation engine 130 may, based on the fragments, generate a plurality of entities. Each entity represents a schematically structured representation of one or more fragments. In particular, an industry standard schema which provides a vocabulary used to structure metadata for online and offline data. In some embodiments, each entity may be generated based on a pre-defined correlation of one or more fragments to an entity. In some embodiments, each entity may be generated based on comparing one or more fragments to contextual data derived from a large language model (LLM) used to interpret existing entities or existing fragments. In some embodiments, each entity may be generated (or obtained) via various searching techniques. Searching techniques can include web-crawling (or web-scraping) for entities associated with one or more fragments, an application programming interface (API) of the application for entities associated with one or more fragments, a software development kit (SDK) of the application for entities associated with one or more fragments, semantic text matching for entities associated with one or more fragments, reverse image searching for entities associated with one or more fragments, etc.

The page generation engine 130 may generate, based on the plurality of entities derived from the fragments, a page. The page may be an applet that performs specific functionality associated with the application. For example, a page may be pre-designed and stored in data store 110 which incorporates one or more functionalities that mimic the application.

In some embodiments, the page generation engine 130 may identify one or more functional components associated with an entity to be merged with the entity. The page generation engine 130 may include a functional mapping database. The functional mapping database includes a plurality of entries. Each entry maps one or more pre-developed functional component that provides functionality that allows a user to interact with an entity. For example, the entity may be a song and the pre-developed functional component may be functionality to listen to the song. An identifier of an entity is used to index each entry of the functional mapping database. Accordingly, a pre-developed functional component may be merged with each entity. Depending on the embodiment, if the entity does not include any corresponding pre-develop functional component, a machine learning model may develop the functional component to be merged with the entity. The machine learning model may be trained to understand the application and the reliance, contribution, and/or constraints of the entity to the application and based on this understanding generate a functional component composing code to mimic the reliance, contribution, and/or constraints of the entity to the application.

In some embodiments, the page generation engine 130 may identify a page layout. The page layout may be stored in a data store 110. The page layout defines a UI structure for a page. Each page layout includes one or more UI elements (e.g., structural UI elements and/or content) positioned in specific locations of the page. Each UI element of the page layout may include a label. The label identifies a specific entity to be used in place of the UI element.

The page generation engine 130 includes a layout database. The layout database includes a plurality of entries. Each entry includes a page layout and is indexed by a category tag. Category tags indicate an application genre (or, more specifically, an application sub-genre). Category tags may include, for example, writing/editing applications, note-taking applications, social gaming applications, photo applications, music streaming applications, video sharing applications, travel applications, web browsing applications, etc. The page generation engine 130 may identify a category tag associated with the application.

In some embodiments, the page generation engine 130 may not be able to directly identify the category tag associated with the application or may indicate that there is a better category tag to assign to the application. The page generation engine 130 may identify, based on the entity or a method of obtaining the entity, a category tag for each entity of the plurality of entities. In some embodiments, the page generation engine 130 determines a category tag associated with the application based on whether most of the entities of the plurality of entities are determined to be a specific category tag. In another embodiment, the page generation engine 130 uses each unique category tag associated with an entity of the plurality of entities (e.g., a unique category tag identified for a corresponding entity) to retrieve a page layout from the page layout database to be segmented to a portion of the page. In another embodiment, the page generation engine 130 uses each unique category tag to retrieve a page layout from the page layout database. It combines the retrieved page layouts into a single cohesive page layout.

Depending on the embodiment, the page generation engine 130 may modify the page layout based on ranking. The page generation engine 130 may rank each of the plurality of entities. For example, ranking may be based on a knowledge graph that tracks engagement and/or usage of previously generated entities. Based on entities with high engagement and/or usage, the page generation engine 130 may rank each entity of the plurality of entities. The page generation engine 130, based on ranking of each entity, identifies a new position within the page layout to incorporate an entity that does not have a designated location (or position) in the page layout.

The page generation engine 130 may build the page, based on the page layout and the plurality of entities. For example, for each UI element of the page layout, the page generation engine 130 queries, using a label of a respective UI element, to identify a corresponding entity to replace the respective UI element. Replacing the respective UI element with the corresponding entity includes incorporating the functional component and/or content associated with the corresponding entity into the UI element. For example, if a functional component is a link to a website, the UI element may be modified to upon a click of the UI element redirect the user to the website. In another example, if the functional component is to play a song, the UI element may be modified to upon a click of the UI element cause media to play.

Once the page is built, the page generation engine 130 may deploy the page directly to the client device 102A-N, data store 110, and/or server 150. The page generation engine 130 may provide user access to the page. The page generation engine 130 may determine that the screenshot used to generate the page has been modified. Responsive to determining that the screenshot used to generate the page has been removed, the page generation engine 130 may revoke access to the page and remove the page from the client device 102A-N, data store 110, and/or server 150.

Depending on the embodiment, in which multiple screenshots are used to generate a single page, responsive to determining that at least one screenshot has been removed, the page generation engine 130 may identify the UI elements of the page that were dependent on one or more entities associated with the screenshot. The page generation engine 130 may remove the identified UI elements based on each removed screenshot.

Depending on the embodiment, in which multiple screenshots are used to generate a single page, responsive to determining that at least one screenshot has been added, the page generation engine 130 may determine whether one or more new entities associated with the added screenshot may be used to modify the page. Accordingly, the page is re-generated in view of the one or more new entities. For example, the page generation engine 130 may identify a new page layout and integrate the one or more new entities into the new page layout. The re-generated page may be deployed, revoke access to a current page (i.e., page deployed based on the multiple screenshots not including the added screenshot), and provide the user access to the re-generated page. Alternatively, the page generation engine 130 may update portions of the current page to reflect the changes associated with the added screenshot. In some embodiments, the user may continue to have access to the current page and witness the changes to the current page. In other embodiments, the page generation engine 130 may temporarily revoke access, update the current page, and then restore access.

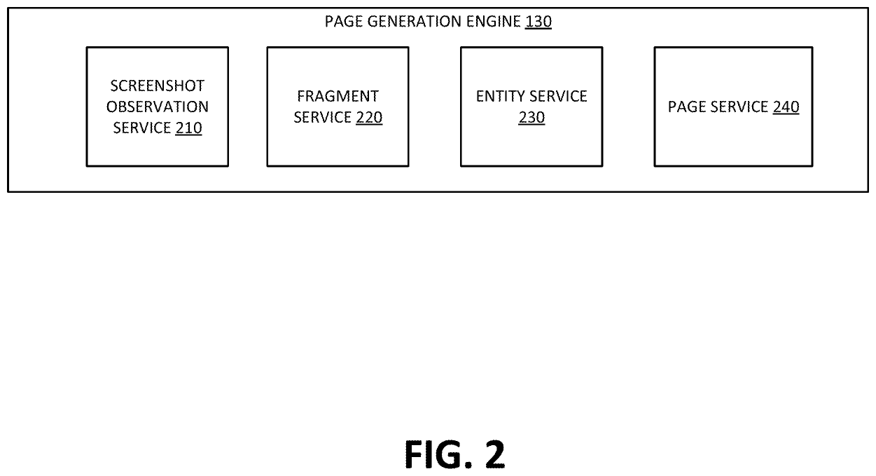

FIG. 2 illustrates a block diagram of an example page generation engine 130 (of FIG. 1) which includes a screenshot observation service 210, a fragment service 220, an entity service 230, and a page service 240 used to dynamically generate pages based on screenshots, in accordance with some embodiments of the present disclosure.

Screenshot observation service 210 may receive (or retrieve) one or more screenshots. Screenshot observation service 210 may obtain observation data from the screenshot. Screenshot observation service 210 may provide the observation data to the fragment service 220.

Fragment service 220 may receive the observation data from the screenshot observation service 210. Fragment service 220 may, based on the observation data, identify an application within the screenshot. In some embodiments, fragment service 220 identifies, within the application of the screenshot, structural user interface (UI) elements, content (e.g., non-structural UI elements), and a current state of the application (or application state). Fragment service 220 extracts, from the screenshot, the identified structural element, content, and application state to generate fragments. Depending on the embodiment, based on the observation data and the identified application, additional fragments associated with the structural UI, content, and/or application state derived from the screen may be extracted from external sources (e.g., a website). Accordingly, fragments may correspond to explicit and/or implicit contextual information derived from the screenshot based on the observation data. Fragment service 220 may provide the fragments to the entity service 230.

Entity service 230 may receive the fragments from the fragment service 220. Entity service 230, based on the fragments, generates a plurality of entities. Each entity represents a schematically structured representation of one or more fragments. Entity service 230 may provide the plurality of entities to the page service 240.

Page Service 240 may receive the plurality of entities from the entity service 230. Page service 240 generates, based on the plurality of entities derived from the fragments, a page. In particular, page service 240, based on the plurality of entities, determines which respective entity to merge with a functional component. Page service 240, based on the plurality of entities, identifies a page layout. Page service 240 may perform additional ranking and recommendations to modify the page layout based on the plurality of entities. Page service 240 builds the page based on the plurality of entities (i.e., entities with functional components and those without) and the page layout. Page service 240 deploys the page for further access by the client device 102A-N of FIG. 1.

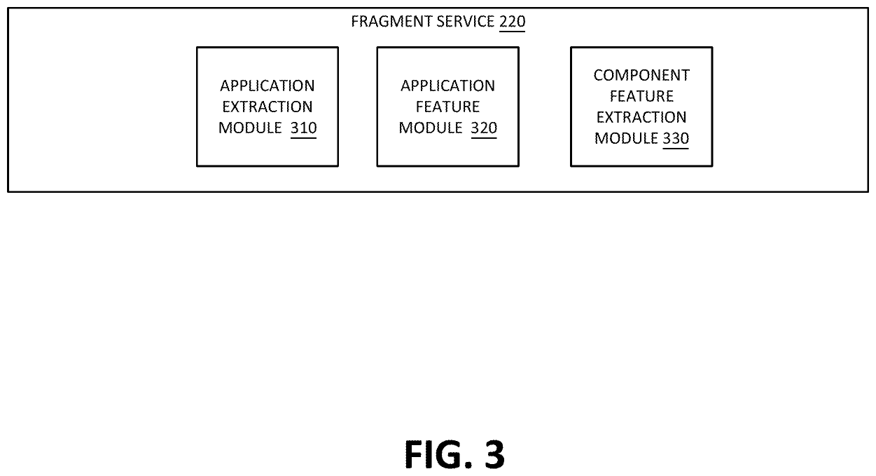

FIG. 3 illustrates a block diagram of fragment service 220 of FIG. 2, in accordance with some embodiments of the present disclosure. Fragment service includes application extraction module 310, application feature module 320, and component feature extraction module 330.

In response to the fragment service 220 receiving observation data from a screenshot observation service (e.g., screenshot observation service 210 of FIG. 2), application extraction module 310 may utilize the observation data to identify an application of the screenshot. In particular, application extraction module 310 may derive an explicit and/or implicit resolution as to the actual application within the screenshot. Based on the explicit and/or implicit resolution of the application, application feature module 320 may extract application markers from the screenshot and generate corresponding fragments associated with the extracted application markers. In some embodiments, fragments generated based on the extracted application markers may include an application state. Application state, for example, may correspond to a dark mode, viewing screen/profile view, a song playing, a notification being displayed. Component feature extraction module 330 may extract all other features from the screenshot and generate corresponding fragments associated with the extracted features. In some embodiments, fragments generated based on the extracted features may include a feature state. Feature state, for example, may correspond to a time elapsed on podcast, a follow relationship between screenshotted content producer and screenshotted, a favorited post, a heart icon filled, a thumbs up pressed, a text highlighted, etc.

Additionally, each fragment may be categorized as a strong domain and/or a weak domain. Fragments categorized as strong domains refer to explicit resolution as to the actual application, application state, features, and feature state (i.e., explicitly associated with a resource location, such as URL, username, description, etc.). Fragments categorized as weak domains refer to implicit resolution as to the actual application, application state, features, and feature state (i.e., derived from the context of the screenshot).

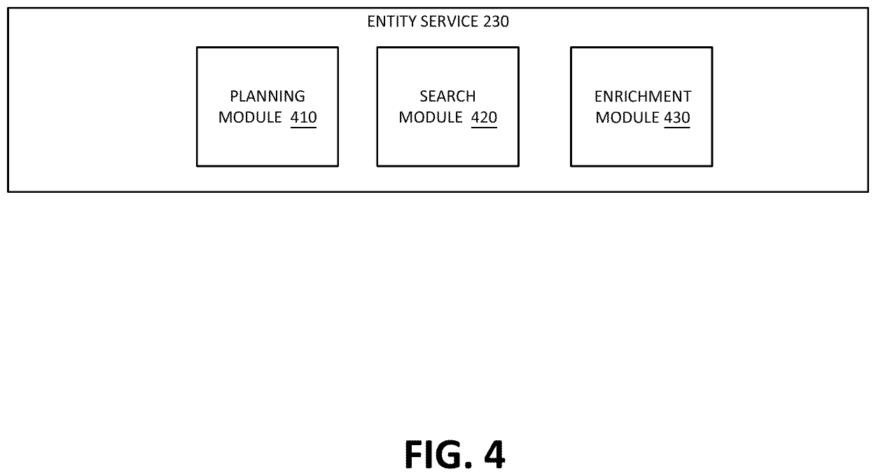

FIG. 4 illustrates a block diagram of entity service 230 of FIG. 2, in accordance with some embodiments of the present disclosure. Entity service 230 includes planning module 410, search module 420, and enrichment module 430.

In response to the entity service 230 receiving a plurality of fragments from fragment service (e.g., fragment service 220 of FIG. 2), planning module 410 may determine a suitable search method for obtaining information used to structure an entity according to a schema for each fragment. In particular, suitable search methods may include a web-based search (e.g., web crawling), utilizing an LLM, or other search methods (e.g., image-based search). Image-based search may be utilizing reverse image search, or other computer vision searching techniques. Accordingly, planning module 410 provides, based on the context from a respective fragment and its categorization (e.g., strong domain or weak domain), the respective fragment to one of the suitable search methods.

For example, based on the context from a fragment being text-based and the fragment being categorized as a strong domain, planning module 410 provides the fragment to a web-based search method of search module 420 to obtain strong domain information to structure the entity according to a schema. In another example, based on the context from a fragment being text-based and the fragment being categorized as a weak domain, planning module 410 provides the fragment to an LLM of search module 420 to assist in conceptualizing the fragment to identify the relevant domain information associated with the fragment to structure the entity according to a schema. In some embodiments, prompt engineering may be used to generate an input with the fragment and produce a reliable output. The subsequent output may be provided to the web-search-method to further obtain strong domain information to structure the entity according to a schema. In yet another example, based on the context from a fragment being image-based, planning module 410 provides the fragment to an image-based search method of search module 420 to assist in obtaining relevant domain information associated with the fragment to structure the entity according to a schema. Depending on the embodiment, a combination of fragments may be combined and provided to one or more suitable search methods to produce a strong domain information associated with the combination of fragments.

For each information (strong domain information and/or weak domain information), enrichment module 430 may generate enriched items (strong domain enriched items and/or weak domain enriched items, respectively). Enriched items correspond to a schema including information. For example, all information from a strong domain information relevant to a specific schema is included in the schema to generate a strong domain enriched item. Each enriched item (strong domain enriched items and/or weak domain enriched items) generated by the enrichment module 430 may be persistently stored as an entity in a database (e.g., a database stored in datastore 110). Accordingly, all the enriched items generated from the fragments are combined into a plurality of entities.

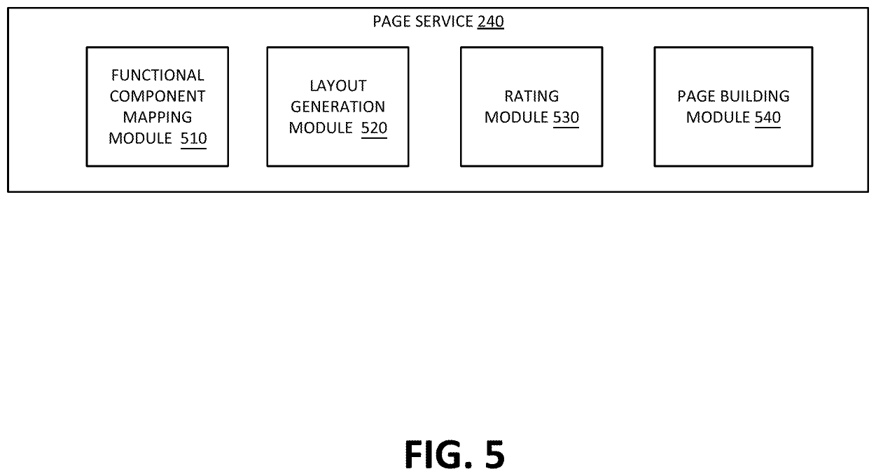

FIG. 5 illustrates a block diagram of page service 240 of FIG. 2, in accordance with some embodiments of the present disclosure. Page service 240 includes functional component mapping module 510, layout generation module 520, rating module 530, and page building module 540.

In response to the page service 240 receiving a plurality of entities from the entity service (e.g., entity service 230 of FIG. 2), functional component mapping module 610 may, for each entity of the plurality of entities, may determine whether to obtain a functional component (e.g., accessing a web resource, playing song, making a reservation, calling a contact, taking a picture) associated with a respective entity. In particular, some entities of the plurality of entities correspond to content of the application, thereby not requiring any functional component. Those that do, as previously described, functional component mapping module 610 may query a functional mapping database to obtain a corresponding functional component. The corresponding functional component is integrated into the respective entity.

Layout generation module 620, either subsequently and/or simultaneously, may identify a page layout in view of the plurality of entities. In particular, as previously described, a page layout may be determined by categorizing the application, or each of the plurality of entities. Layout generation module 620 may further modify the page layout based on varying categorizations of one or more entities of the plurality of entities. Rating module 630 may rank each entity of the plurality of entities and provide further modification to the page layout.

Once the page layout is obtained and, in some instances, modified, page building module 640 may generate the page based on the page layout and the plurality of entities. As previously described, the page layout includes a plurality of UI elements each labeled. Labels of the UI element are used to reference an entity. According for each label associated with a UI element, a corresponding entity of the plurality of entities is identified to replace the UI element. Replacing the UI element with the entity may include including the content of the entity into the UI element or including the functional component of the entity into the UI element so that when interacted with implements the functional component (e.g., accessing a web resource, playing song, making a reservation, calling a contact, taking a picture).

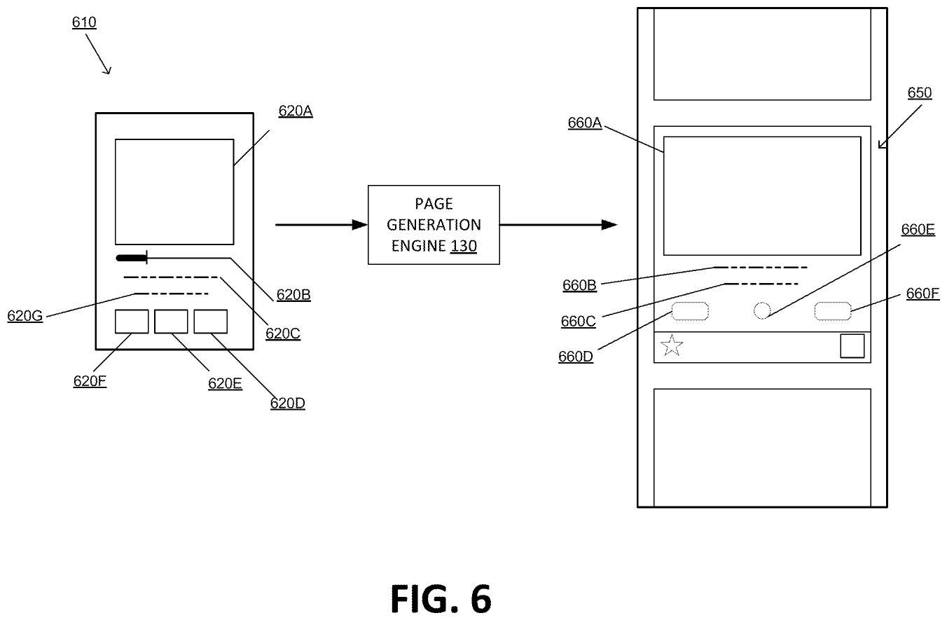

FIG. 6 illustrates a page 650 generated from a screenshot 610, in accordance with some embodiments of the present disclosure. As previously described, screenshot 610 may be stored for example in a client device (e.g., client device 102A-N). Screenshot 610 may be provided to a page generation engine (e.g., page generation 130 of FIG. 1). Page generation engine 130 may obtain observations (e.g., observation data) from screenshot 610. Observation may be of each UI element of screenshot 610 (e.g., 620A-G). Page generation engine 130 generates a plurality of fragments based on the observation data. Page generation engine 130, for each fragment of the plurality of fragments, generate one or more entity. Each of the one or more entities associated with a fragment of the plurality of fragments make up the plurality of entities used to generate page 650. Page generation engine 130 may modify a subset of the entities to incorporate a functional component (or functionality). Page generation engine 130 may further identify, based one or more entities, a page layout used to generate page 650. The page layout may be further modified by the page generation engine 130 based on a ranking of the plurality of entities. Based on the page layout and the plurality of entities, page generation engine 130 may build page 650 by updating each of the UI elements (e.g., 660A-F) of the page layout with an entity of the plurality entities to generate page 650.

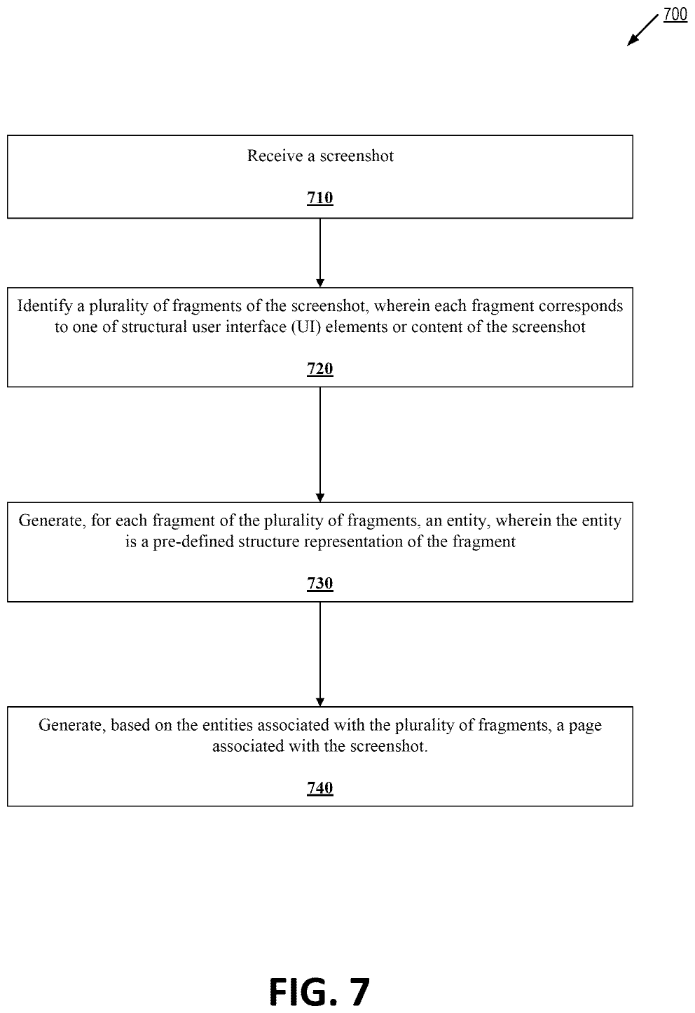

FIG. 7 is a flow diagram of an example method 700 of dynamically generating a page using one or more screenshots in accordance with some embodiments of the present disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by the page generation engine 130 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 710, the processing logic receives a static screenshot. At operation 720, the processing logic identifies a plurality of fragments of the screenshot. Each fragment may correspond a structural user interface (UI) elements or content of the static screenshot. In some embodiments, the processing logic receives observation data of the static screenshot. The processing logic identifies an application within the static screenshot. The processing logic extracts, from the application within static screenshot, the structural UI elements, content, or application state. The processing logic generates, based on the structural UI elements, content, or application state, the plurality of fragments. As previously described, the observation data is utilized to identify an application of the screenshot. Explicit and/or implicit resolution as to the actual application within the screenshot is derived. Based on the explicit and/or implicit resolution of the application, application markers, application state, features, and feature states are used to generate corresponding fragments.

At operation 730, the processing logic generates, for each fragment of the plurality of fragments, an entity. The entity is a pre-defined structure representation of the fragment. In some embodiments, for each fragment of the plurality of fragments, the processing logic identifies a pre-defined schema associated with a respective fragment. The processing logic obtains information associated with the respective fragment. The processing logic generates, based on the obtained information and the pre-defined schema, the entity. As previously described, various search methods (e.g., text-based search methods and/or image-based search methods) are used to obtain information to structure the entity according to a pre-defined schema. For each fragment the obtained information is used to generate an enriched item (or entity).

At operation 740, the processing logic generates, based on the entities associated with the plurality of fragments, a page associated with the static screenshot. The page may be an applet that provides similar or additional functionality to the screenshot in a page layout.

In some embodiments, responsive to determining that an entity corresponds to a structural UI element of the static screenshot, the processing logic integrates the entity with a functional component. The functional component may be a pre-developed functionality mimicking a structural UI element of static screenshot or functionality developed on-demand mimicking a structural UI element of static screenshot. The processing logic obtains, based on the entities associated with the plurality of fragments, a page layout. Depending on the embodiment, the processing logic may rank the entities associated with the plurality of fragments and modify, based on rankings, the page layout. The processing logic generates, based on the entities associated with the plurality of fragments and the page layout, the page. As previously described, the page layout includes a plurality of UI elements each labeled to reference an entity. According, for each label associated with a UI element, a corresponding entity of the plurality of entities is identified to replace the UI element by including the content of the entity into the UI element or including the functional component of the entity into the UI element so that when interacted with implements the functional component.

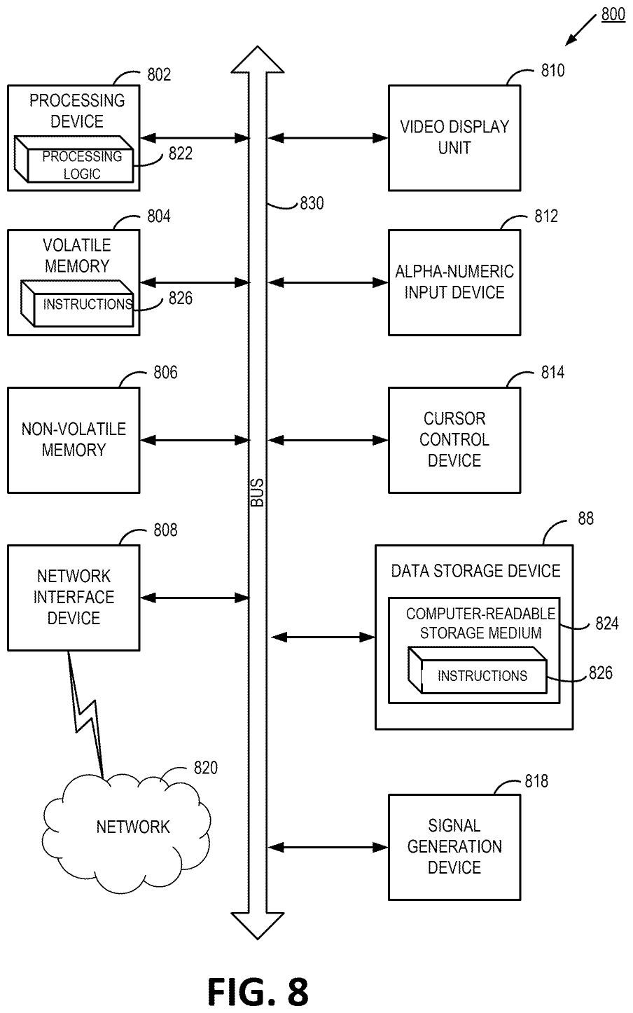

FIG. 8 depicts an example computer system 800 which can perform any one or more of the methods described herein. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any screenshot of computers that individually or jointly execute a set (or multiple sets) of instructions to perform any one or more of the methods discussed herein.

The exemplary computer system 800 includes a processing device 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)), and a data storage device 816, which communicate with each other via a bus 808.

Processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. The processing device 802 is configured to execute instructions 826 for implementing the page generation engine 130 of FIG. 1 and to perform the operations and steps discussed herein (e.g., method 600 of FIG. 6).

The computer system 800 may further include a network interface device 822. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 820 (e.g., a speaker). In one illustrative example, the video display unit 810, the alphanumeric input device 812, and the cursor control device 814 may be combined into a single component or device (e.g., an LCD touch screen).

The data storage device 816 may include a computer-readable storage medium 824 on which is stored the instructions 826 embodying any one or more of the methodologies or functions described herein. The instructions 826 may also reside, completely or at least partially, within the main memory 804 and/or within the processing device 802 during execution thereof by the computer system 800, the main memory 804 and the processing device 802 also constituting computer-readable media. In some implementations, the instructions 826 may further be transmitted or received over a network via the network interface device 822.

While the computer-readable storage medium 824 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts concretely. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method comprising:
receiving a screenshot;
identifying a plurality of fragments of the screenshot, wherein each fragment corresponds to one of: structural user interface (UI) elements or content of the screenshot;
generating, for each fragment of the plurality of fragments, an entity, wherein the entity is a pre-defined structure representation of the fragment;
generating, based on the entities associated with the plurality of fragments, at least one page associated with the screenshot.

2. The method of claim 1, wherein the at least one page is an applet that provides at least one of: similar or additional functionality to the screenshot in a page layout.

3. The method of claim 1, wherein identifying a plurality of fragments of the screenshot comprises:
receiving observation data of the screenshot;
identifying an application within the screenshot;
extracting, from the application within screenshot, at least one of: the structural UI elements, content, or an application state; and
producing, based on the at least one of: the structural UI elements, content, or an application state, the plurality of fragments.

4. The method of claim 1, wherein generating the entity, comprises:
for each fragment of the plurality of fragments, identify a pre-defined schema associated with a respective fragment;
obtain information associated with the respective fragment; and
generate, based on the obtained information and the pre-defined schema, the entity.

5. The method of claim 1, wherein generating the at least one page comprises:
responsive to determining that an entity corresponds to a structural UI element of the screenshot, integrating the entity with a functional component;
obtaining, based on the entities associated with the plurality of fragments, a page layout;
producing, based on the entities associated with the plurality of fragments and the page layout, the at least one page.

6. The method of claim 5, wherein the functional component is a one of: a pre-developed functionality mimicking a structural UI element of screenshot or functionality developed on-demand mimicking a structural UI element of screenshot.

7. The method of claim 5, further comprising:
ranking the entities associated with the plurality of fragments; and
modifying, based on ranking of the entities associated with the plurality of fragments, the page layout.

8. A system comprising:
a memory; and
a processor, operatively coupled with memory, to perform operations comprising:
receiving a screenshot;
identifying a plurality of fragments of the screenshot, wherein each fragment corresponds to one of: structural user interface (UI) elements or content of the screenshot;
generating, for each fragment of the plurality of fragments, an entity, wherein the entity is a pre-defined structure representation of the fragment;
generating, based on the entities associated with the plurality of fragments, at least one page associated with the screenshot.

9. The system of claim 8, wherein the at least one page is an applet that provides at least one of: similar or additional functionality to the screenshot in a page layout.

10. The system of claim 8, wherein identifying a plurality of fragments of the screenshot comprises:
receiving observation data of the screenshot;
identifying an application within the screenshot;
extracting, from the application within screenshot, at least one of: the structural UI elements, content, or an application state; and
producing, based on the at least one of: the structural UI elements, content, or an application state, the plurality of fragments.

11. The system of claim 8, wherein generating the entity, comprises:
for each fragment of the plurality of fragments, identify a pre-defined schema associated with a respective fragment;
obtain information associated with the respective fragment; and
generate, based on the obtained information and the pre-defined schema, the entity.

12. The system of claim 8, wherein generating the at least one page comprises:
responsive to determining that an entity corresponds to a structural UI element of the screenshot, integrating the entity with a functional component;
obtaining, based on the entities associated with the plurality of fragments, a page layout;
producing, based on the entities associated with the plurality of fragments and the page layout, the at least one page.

13. The system of claim 12, wherein the functional component is a one of: a pre-developed functionality mimicking a structural UI element of screenshot or functionality developed on-demand mimicking a structural UI element of screenshot.

14. The system of claim 12, wherein the processor is caused to perform operations further comprising:
ranking the entities associated with the plurality of fragments; and
modifying, based on ranking of the entities associated with the plurality of fragments, the page layout.

15. A non-transitory computer-readable storage medium comprising instructions that, when executed by a processing device, cause the processing device to perform operations comprising:
receiving a screenshot;
identifying a plurality of fragments of the screenshot, wherein each fragment corresponds to one of: structural user interface (UI) elements or content of the screenshot;
generating, for each fragment of the plurality of fragments, an entity, wherein the entity is a pre-defined structure representation of the fragment;
generating, based on the entities associated with the plurality of fragments, at least one page associated with the screenshot.

16. The non-transitory computer-readable storage medium of claim 15, wherein the at least one page is an applet that provides at least one of: similar or additional functionality to the screenshot in a page layout.

17. The non-transitory computer-readable storage medium of claim 15, wherein identifying a plurality of fragments of the screenshot comprises:
receiving observation data of the screenshot;
identifying an application within the screenshot;
extracting, from the application within screenshot, at least one of: the structural UI elements, content, or an application state; and
producing, based on the at least one of: the structural UI elements, content, or an application state, the plurality of fragments.

18. The non-transitory computer-readable storage medium of claim 15, wherein generating the entity, comprises:
for each fragment of the plurality of fragments, identify a pre-defined schema associated with a respective fragment;
obtain information associated with the respective fragment; and
generate, based on the obtained information and the pre-defined schema, the entity.

19. The non-transitory computer-readable storage medium of claim 15, wherein generating the at least one page comprises:
responsive to determining that an entity corresponds to a structural UI element of the screenshot, integrating the entity with a functional component;
obtaining, based on the entities associated with the plurality of fragments, a page layout;
producing, based on the entities associated with the plurality of fragments and the page layout, the at least one page.

20. The non-transitory computer-readable storage medium of claim 19, wherein the functional component is a one of: a pre-developed functionality mimicking a structural UI element of screenshot or functionality developed on-demand mimicking a structural UI element of screenshot.
